(19) United States
(12) Patent Application Publication
(10) Pub. No.: US 2019/0357692 A1
(43) Pub. Date: Nov. 28, 2019

(54) Pair of half round shoulder bolsters of various sizes and firmnesses

(71) Applicant: Anne Gallone, Westport, MA (US)

(72) Inventor: Anne Gallone, Westport, MA (US)

(21) Appl. No.: 16/418,110

(22) Filed: May 21, 2019

Related U.S. Application Data
(60) Provisional application No. 62/674,927, filed on May 22, 2018.

(51) Int. Cl. A47C 20/02; A61H 37/00

(52) U.S. Cl. CPC A47C 20/026; A61G 2200/325; A61H 37/00

(57) ABSTRACT

A half round shaped pair of shoulder bolsters are disclosed herein to support the shoulders of a person kept in the prone position for any length of time. These bolsters come in different sizes and firm nesses to accommodate most people from a small child through a large adult. They hold the shoulders back, which alleviates some pressure on the face and chest allowing the person to breathe better. The embodiments are comprised of, but not limited to, a soft, washable PU Leather outer with a zipper closure and the filler is made of various firmnesses of foam. The smaller size bolster has the least firmness to be used for a child or small adult. The firmness increases with the size of the bolster to accommodate for the increased weight of a larger person. Different materials can be used for the outer casing, closure and filler to provide shoulder support.

### RELATED APPLICATION

This application claims the benefit of priority to the U.S. Provisional Patent Application for “Shoulder Bolster” Application No. Ser. No. 62/674,927 filed on May 22, 2018 and currently co-pending.

### FIELD OF THE INVENTION

The present invention is designed to add comfort to a person laying in the prone position for a prolonged period of time such as a client during a massage, a patient while receiving medical treatment or even a person sleeping.

### BACKGROUND

Massage therapists have their clients in the prone position for about half an hour. As a massage therapist myself, we were told to use a towel, but the towel does not stay in place and unravels during the massage. The towels create more laundry. Other shoulder bolsters on the market are shaped differently and do not accommodate for the size and weight of a person.

Medical tests and treatments such as MRIs and radiation require patients to be in the prone position for up to an hour. My sister, who has been battling cancer for 10 years, said these bolsters would make some cancer treatments, MRIs and other tests much more comfortable.

The goal of this invention is to have shoulder bolsters that would not only provide support and comfort, but also stay in place especially while massaging the rotator cuff muscles.

US20160073802A1 Reveals a multi-position, multi-purpose pillow has V-shaped cut outs on the medial ends of the pillow to accommodate a sleeper's shoulder.

KR101590068 The present invention, a functional cushion is provided to correct a posture. The functional cushion for correcting a posture includes an upper cushion in which a body support is connected to a head support.

U.S. Pat. No. 5,566,682A Therapeutic support device to provide a pair of shoulder support regions, a pair of scapula support regions and a sternum support region to permit a woman to rest or sleep with her chest facing downwardly without placing undue pressure on her breasts.

U.S. Pat. No. 6,047,420A Axillary prone position support system. This invention relates to a system designed to support a person in a substantially face down position during post-surgical recuperation or for other purposes requiring prone positioning.

BR112012022189 A breast protective system and orthosis. This one piece, bone-shaped pillow can help relieve some pressure on breasts. It has a central portion extending along a longitudinal axis of the orthosis to be receivable between the breasts of the subject to support the sternum and opposed portions extending bilaterally outwardly from a cephalad end of the central portion to support the clavicle and/or upper ribcage.

US20170181555A1 Chest support pillow. The pillow may be used to provide support to a user's chest and front side when lying face down during activities including massage, sleep, chiropractic therapy, and medical procedures.

### Disadvantages of Existing Art:

1. Prior art does not vary in size and firmness to accommodate different body types.
2. Prior art does not include half round shaped bolsters, cushions or pillows for the shoulders.
3. Some designs have indents for shoulders in the prone position, but they do not consider that the sternum bone protrudes out further than the shoulder bone and the comfort is minimal.
4. Some shoulder supports are one piece connected in the middle under the sternum limiting the span of shoulder width.
5. Other existing art requires adjusting. A person laying naked on a massage table may get annoyed with this.

### SUMMARY OF INVENTION

The intention of this invention is to provide a unique shoulder bolster having adaptations for comfortably supporting the weight and configuration of any person. This invention relates to a pair of shoulder bolsters configured to provide comfortable support for a person in the prone position. As shoulders are positioned further back than the sternum, the shoulder bolsters help align the shoulders back where they should be. If you hold the palm of your hand against the middle of your chest and point your fingers straight up, you can clearly see this gap. The bolsters especially help alleviate some pressure on the face and chest, both of which allow the person to breathe better. Anyone who needs to lie in the prone position for a prolonged period of time, can be more comfortable with these bolsters.

Similar support systems do not vary in size or firmness, are not as versatile and are not as durable.

Therefore, it is among the primary object of the present invention to provide a unique shoulder bolster having adaptations for comfortably supporting the weight and configuration of any person in a prone position.

Another object of the present invention is to have a shoulder bolster that stays in place while the rotator cuff muscles are being massaged.

Yet another object of the present invention is to have a pair of shoulder bolsters to accommodate for narrow or broad shoulders.

Still another object of the present invention is to provide a sleek, easily storable product with a tiny washable pillowcase to minimize laundry.

### BRIEF DESCRIPTION OF DRAWINGS

For simplicity of illustration, thread sewn seams common on bolsters are not depicted as they are known to those with skill in the art. The illustrations do not capture all embodiments of the invention disclosed.

FIG. 1 is a sideview of the shoulder bolster under a person being massaged;

FIG. 2 is a pair of shoulder bolsters;

FIG. 3 is a pair of shoulder bolsters with pillowcases;

FIG. 4 is a shoulder bolster with a button closure;

FIG. 5 is a shoulder bolster with a hook and loop closure;

FIG. 6 is a shoulder bolster with a snap closure; and

FIG. 7 is a shoulder bolster with a zipper closure.

FIG. 8 shows three different sizes of the shoulder bolsters

### DETAILED DESCRIPTION OF DRAWINGS

The various embodiments and variations thereof illustrated in the accompanying figures and/or described herein are merely exemplary and are not meant to limit the scope of the invention. It is to be appreciated that numerous variations of the invention have been contemplated as would be obvious to one of ordinary skill in the art with the benefit of this disclosure. Rather, the scope and breadth afforded this document should only be limited by the claims provided herein while applying either the plain meaning to each of the terms and phrases in the claims or the meaning clearly and unambiguously provided in this specification.

### Terminology

The terms and phrases as indicated in parenthesis (“ ”) in this section are intended to have the meaning ascribed to them in this section applied to them throughout this document including the claims unless clearly indicated otherwise in context. The term “or” as used in this specification and the appended claims is not meant to be exclusive rather the term is inclusive meaning “either or both”. References in the specification to “one embodiment”, “an embodiment”, “a preferred embodiment”, “alternative embodiments”, “embodiments”, “variations”, “a variation” and similar phrases mean that a particular feature, structure, or characteristic described in connection with the embodiment(s) or variation(s) is included in at least an embodiment or variation of the invention. The appearances of the phrase “in one embodiment” or “in one variation” in various places in the specification are not necessarily all referring to the same embodiment or variation. An embodiment of a unique pair of half round shoulder bolsters in various sizes and firmnesses.

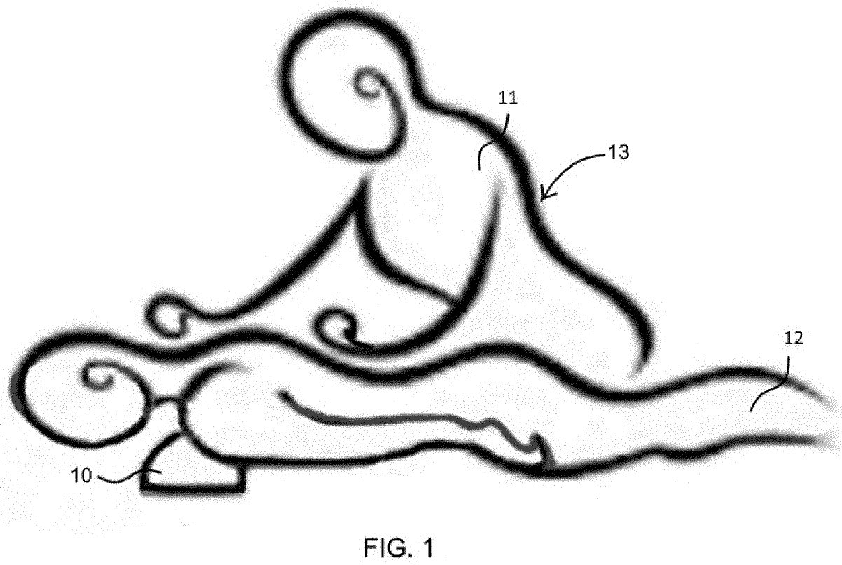

FIG. 1 is an illustration of a shoulder bolster 10 under the shoulder of a client 12 being massaged by a massage therapist 11.

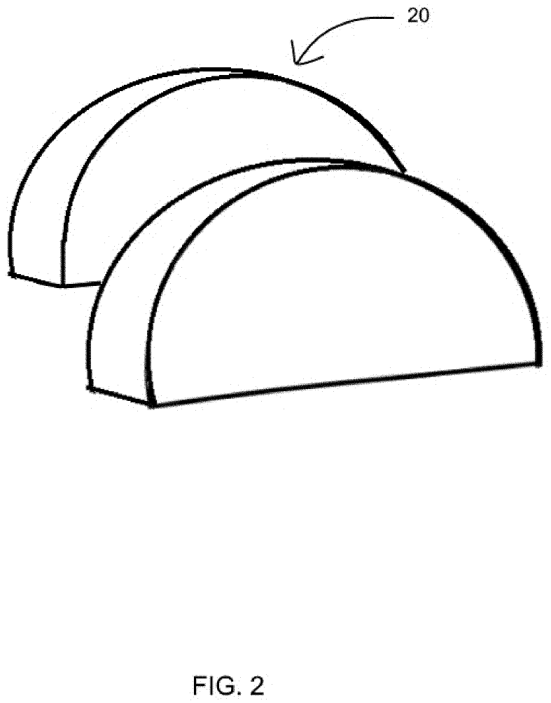

FIG. 2 shows a pair of shoulder bolsters 20. Two separate bolsters can accommodate narrow to broad shoulders averaging 14″ to 21″ apart.

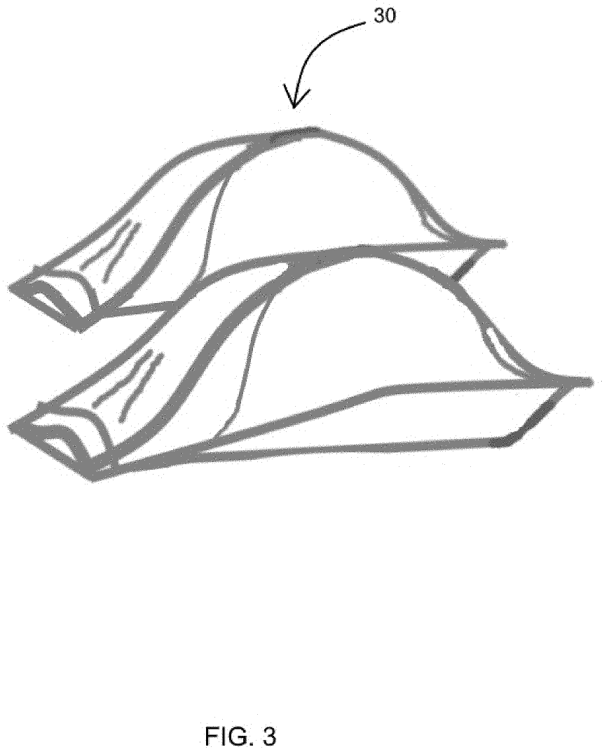

FIG. 3 depicts a pair of shoulder bolsters with pillowcases on them 30. These tiny pillowcases take up much less room in the laundry than the presently used towels by massage therapists. Also, they could be disposable paper pillowcases as may be preferred for medical treatments.

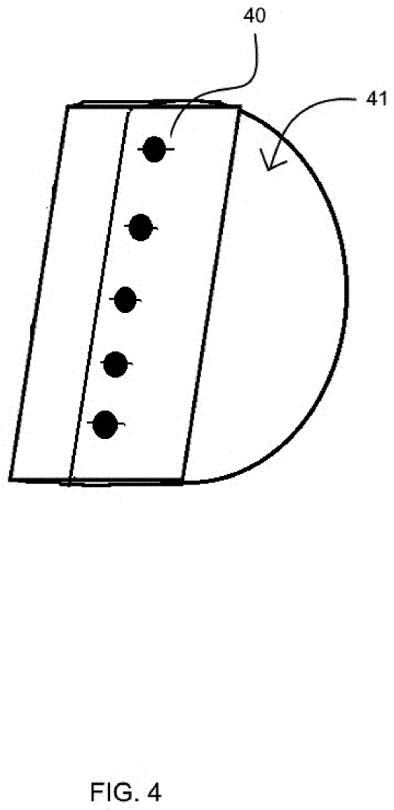

FIG. 4 shows a button closure 40 on a shoulder bolster. This closure would be good if the bolsters were used for an MRI or X-ray. It may be nicer for home use as well especially if the casings were made from flannel or cotton.

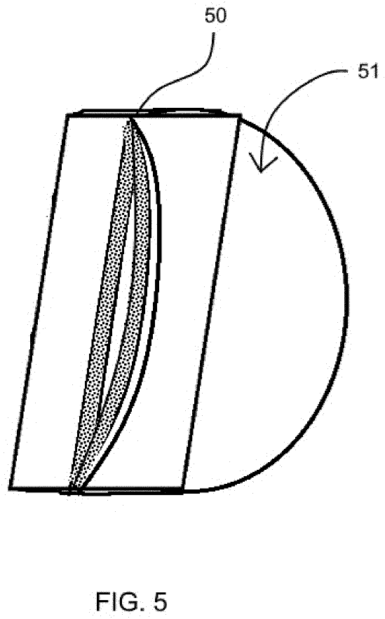

FIG. 5 has a hook and loop closure 50 as may be preferred for the reasons aforementioned.

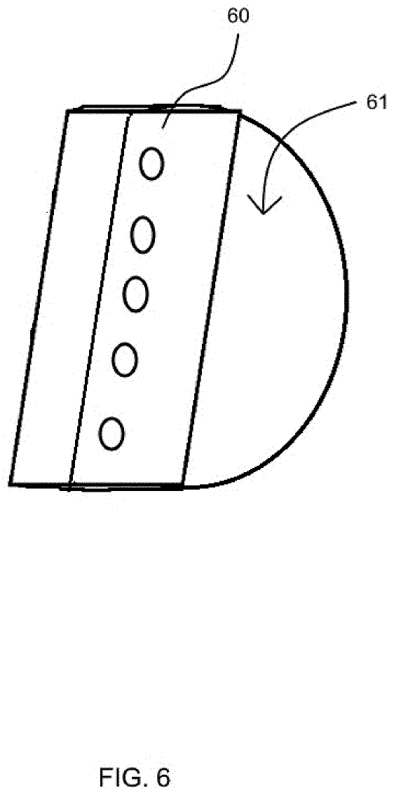

FIG. 6 has a snap closure 60 as may be preferred for aesthetic purposes.

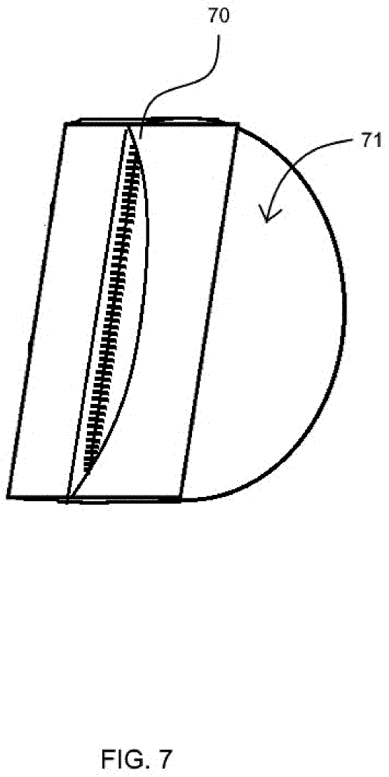

FIG. 7 has a zipper closure 70 as is my choice since it sits flatter than the others.

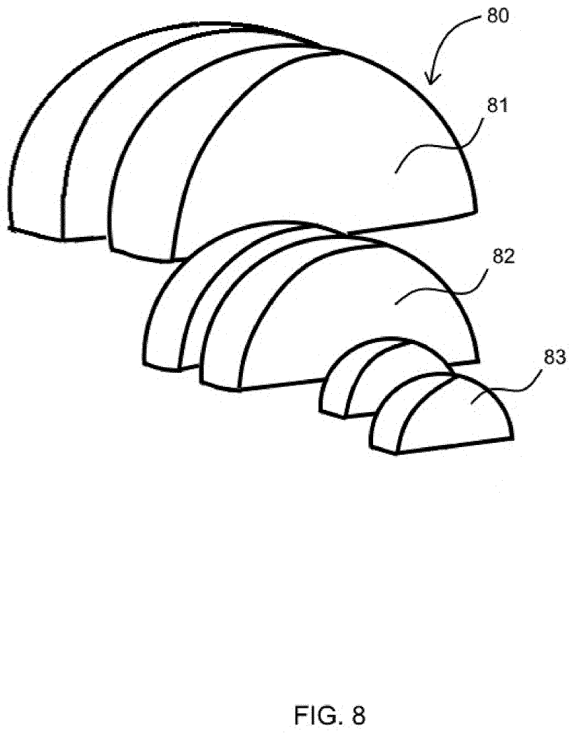

FIG. 8 shows three different sized shoulder bolsters 80. The large bolster 81 has the firmest filler needed to prop up the heavier shoulders of a larger person. The medium bolster 82 has a firm filler needed for the average person. The small bolster 83 is less firm for a child or small adult.

### Specifications

While the preferred embodiment is a washable material casing with a foam filler and a zipper closure at the bottom, alternative embodiments may be used. For example, the casing may need to be an impermeable material with a valve closure for containing other types of fillers such as but not limited to a liquid, gel or air. Further, while it is preferred to form the bolster of a stitched material, other manners of joining the material may be used, such as gluing, heat sealing, or other. The preferred filler is foam. This filler can be interchanged with other types of fillers such as beads, rice, cotton, etc. The preferred material to form the shoulder bolster casing is PU Leather as it is durable and can be wiped clean with an antibacterial wipe.

It may be desired to provide separate pillowcases for additional protection of the bolsters. They can be a smaller version of the traditional pillowcases made of cotton, polyester, bamboo and the like. For use in medical situations, it may be desirable to provide a disposable pillowcase made of a material such as paper, plastic, etc. My preferred pillowcase is made from cotton or a cotton blend.

The embodiments illustrated and described in this specification are not exclusive of other features, embodiments and variations.

1. Half round shaped shoulder bolsters of different sizes and firmnesses to support a person in the prone position, comprising:
a) outer casing sides made of two half round pieces of material;
b) outer casing top made of a rectangular like piece of material;
c) outer casing bottom made of one or two rectangular like pieces of material connected to some type of closure;
d) closure can be achieved with buttons, hook and loop, snaps, zippers, etc.;
e) filler can be of any type such as foam, air, liquid, polyester, plastic pieces, beans, rice, or other material;
f) handles can be attached to each bolster and
g) a tether can be attached to hold the pair of shoulder bolsters together.
